(19) United States
(12) Patent Application Publication
(10) Pub. No.: US 2015/0205876 A1
(43) Pub. Date: Jul. 23, 2015

(54) PROVIDING ACCESS TO A RESOURCE VIA USER-CUSTOMIZABLE KEYWORDS

(71) Applicant: Google Inc., (US)

(72) Inventor: Arthur Edmond Blume, Melrose, MA (US)

(73) Assignee: Google Inc., Mountain View, CA (US)

(21) Appl. No.: 13/843,143

(22) Filed: Mar. 15, 2013

(51) Int. Cl. G06F 17/30

(52) U.S. Cl. CPC G06F 17/30876

(57) ABSTRACT

A system and machine-implemented method for providing access to a resource for an application running on a computing device. Indication of a first character set entered in a data entry area of the application is received, the first character set comprising an operator indicating intent by a user to access a resource. The operator is distinguished from a query entry in the data entry area. Indication of a second character set entered in the data entry area is received, the second character set comprising a keyword identifying the resource. An address of the resource identified by the keyword is determined, based on a data structure which associates keywords with respective addresses of resources. Access to the resource is provided based on the determined address of the resource.

### BACKGROUND

The present disclosure generally relates to accessing resources and, in particular, to providing access to a resource for an application running on a computing device.

Various resource locators such as search engines, Internet directories, etc. have been developed in response to the increasing amount of information that has become available over networks such as the Internet, in addition to the large amounts of data, applications, content, and information often stored on different computing devices owned by many users. Users often use such resource locators to obtain or retrieve information from various sources.

### SUMMARY

The disclosed subject matter relates to a machine-implemented method of providing access to a resource for an application running on a computing device. The method comprises receiving indication of a first character set entered in a data entry area of the application, the first character set comprising an operator indicating intent by a user to access a resource, and distinguishing the operator from a query entry in the data entry area. The method further comprises receiving indication of a second character set entered in the data entry area, the second character set comprising a keyword identifying the resource, determining an address of the resource identified by the keyword, based on a data structure which associates keywords with respective addresses of resources, and providing for access to the resource based on the determined address of the resource.

The disclosed subject matter further relates to a system for providing access to a resource for an application running on a computing device. The system comprises one or more processors, and a machine-readable medium comprising instructions stored therein, which when executed by the processors, cause the processors to perform operations comprising receiving indication of a first character set entered in a text search box of the application, the first character set comprising an operator indicating intent by a user to access a resource. The operations further comprise distinguishing the operator from a query entry in the text search box, and receiving indication of a second character set entered in the text search box, the second character set comprising a keyword identifying the resource. In addition, the operations comprise determining an address of the resource identified by the keyword, based on a data structure which associates keywords with respective addresses of resources, and providing for access to the resource based on the determined address of the resource.

The disclosed subject matter also relates to a machine-readable medium comprising instructions stored therein, which when executed by a system, cause the system to perform operations comprising receiving indication of a first character set entered in a data entry area of an application running on a computing device, the first character set comprising an operator indicating intent by a user to access a resource, the operator comprising a predefined set of characters. The operations further comprise distinguishing the operator from a query entry in the data entry area, and receiving indication of a second character set entered in the data entry area, the second character set comprising a keyword identifying the resource. In addition, the operations comprise determining an address of the resource identified by the keyword, based on a data structure which associates keywords with respective addresses of resources, and providing for access to the resource based on the determined address of the resource.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several embodiments of the subject technology are set forth in the following figures.

FIG. 1 illustrates an example network environment which can provide access to a resource for an application running on a computing device.

FIG. 2 is a block diagram illustrating example components of a system for providing access to a resource for an application running on a computing device.

FIG. 3 illustrates an example of a graphical interface which provides access to a resource for an application running on a computing device.

FIG. 4 illustrates an example of a graphical interface for creating or editing keywords associated with respective resources.

FIG. 5 illustrates an example of a graphical interface for creating a new keyword from a bookmark interface in a web browser.

FIG. 6 illustrates an example process by which access to a resource for an application running on a computing device is provided.

FIG. 7 conceptually illustrates an example electronic system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As noted above, various resource locators such as search engines, Internet directories, etc. have been developed in response to the increasing amount of information that has become available over networks such as the Internet, in addition to the large amounts of data, applications, content, and information often stored on different computing devices owned by many users. Users often use such resource locators to obtain or retrieve information from various sources.

However, locating information can often require knowledge of resource(s) capable of returning relevant results in response to a search query. Aside from the complexity of formulating a search query or keyword for retrieving information using a particular resource locator, a user must have knowledge of and locate the particular resource locator to utilize the resource locator for the search. In addition, when a resource locator is only available on a particular online service, a user may have to first log on to the online service, and then conduct a search for the particular information they are looking for.

Even after a user locates resource locators that may be suited for a search related to a category or keyword, the user must remember which resource locator produced relevant results for the category or keyword to subsequently refer to the desired information. Without the user independently providing the resource locator, other users must independently determine suitability of a resource locator or otherwise find the relevant information. Methods for sharing of resource locators or information among users can include e-mails between friends and colleagues which may contain “favorites” or “bookmarks,” or a list of links for further research on a website. Each user can independently determine the value of resource locators for returning results pertaining to a given subject matter. Access to many web-based applications may also be restricted through the use of authorization keys or other required permissions or user credentials.

The subject disclosure provides for providing access to a resource for an application running on a computing device. A first character set entered in a data entry area of the application is received, the first character set comprising an operator indicating intent by a user to access a resource. The operator is distinguished from a query entry (e.g., a search query entry, a URL entry for a website) in the data entry area. A second character set entered in the data entry area is received, the second character set comprising a keyword identifying the resource. An address of the resource identified by the keyword is determined, based on a data structure which associates keywords with respective addresses of resources. Access to the resource is provided based on the determined address of the resource.

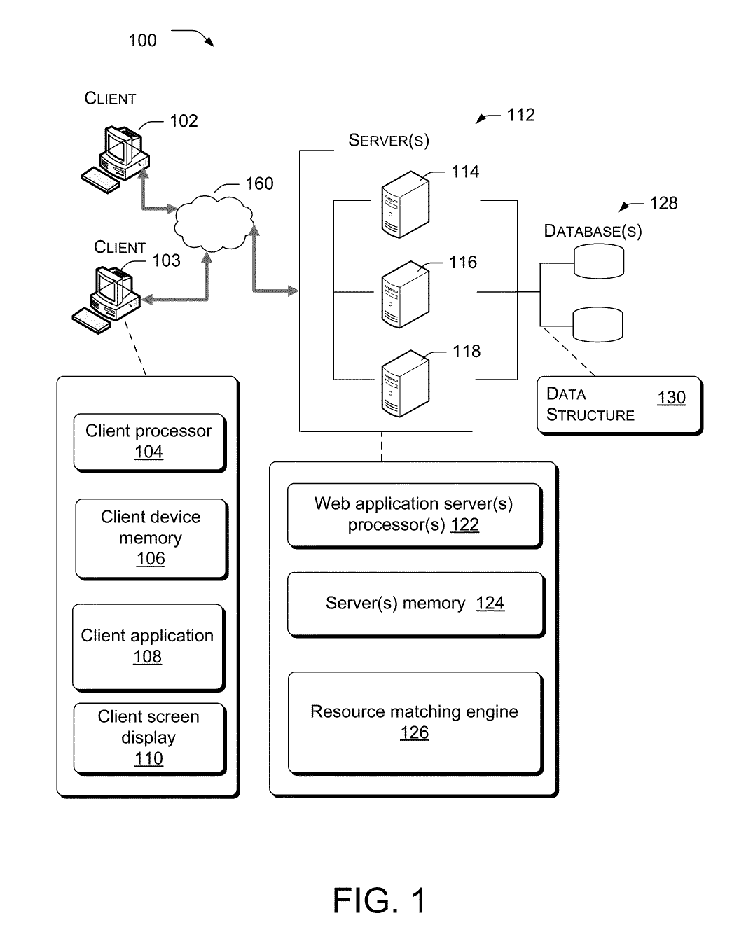

FIG. 1 illustrates an example network environment which can provide access to a resource for an application running on a computing device. In the example of FIG. 1, computing devices 102, 103 are each configured to include an application (e.g., a web browser) for accessing resources. For example, a web browser, among other functions, enables a user to enter addresses of specific web pages the user would like to retrieve. The browser software, or just “browser,” is a user-friendly interface (e.g., front-end) that simplifies access to the Internet. A browser allows a client to communicate a request without having to learn a complicated command syntax, for example. A browser typically provides a graphical user interface (GUI) for displaying information and receiving input.

Information servers such as servers 114, 116, and 118, and associated databases 128, and data structures 130, maintain the information on the Worldwide Web (WWW) and are capable of processing a client request. Hypertext Transport Protocol (HTTP) is the standard protocol for communication with an information server on the WWW. HTTP has communication methods that allow clients to request data from a server and send information to the server.

To submit requests, the clients 102, 103 contact the HTTP servers 114, 116, and 118, and transmit the requests to the servers. The requests contain the communication method requested for the transaction (e.g., GET an object from the server or POST data to an object on the server). The HTTP server responds to the client by sending a status of the request and the requested information. The connection is then terminated between the client and the HTTP server.

A client request therefore, consists of establishing a connection between the client and the HTTP server, performing the request, and terminating the connection. In example aspects, the HTTP server does not retain any information about the request after the connection has been terminated. HTTP can therefore be referred to as a stateless protocol. That is, a client can make several requests of an HTTP server, but each individual request is treated independent of any other request. The server may have no recollection of any previous request.

To protect information in internal computer networks from external access, a firewall can be utilized. A firewall is a mechanism that blocks access between the client and the server. To provide limited access to information, a proxy or proxy server may sit atop a firewall and act as a conduit, providing a specific connection for each network connection. Proxy software retains the ability to communicate with external sources, yet is trusted to communicate with the internal network. For example, proxy software may require a user to perform authentication steps by supplying a username and password in order to access certain sections of the internal network and completely block other sections from any external access.

An addressing scheme is employed to identify Internet resources (e.g., HTTP server, file or program). This addressing scheme assigns a Uniform Resource Locator (URL) to each resource. A URL contains the protocol to use when accessing the server (e.g., HTTP), the Internet domain name of the site on which the server is running, the port number of the server, and the location of the resource in the file structure of the server. A typical addressing scheme such as a URL for information, content, or a resource locator (e.g., a search engine, online database, library, etc.) that a user may desire to access over a distributed network may be too complex and detailed for easy recall at a later time. While a web browser generally allows for the bookmarking of particular URLs that may be of possible later interest to a user, the resulting lists of bookmarks often grow so rapidly that finding a particular bookmark can quickly become as difficult as remembering a particular URL. Furthermore, a user may have to take a significant number of time-consuming steps to get back to a document, file, application, or other resource, including entering required permissions, recalling which service or resource locator they previously used to gain access to the desired information, and entering the exact web address or file path. In addition, a user may like to quickly and easily find a significant resource locator or information of interest at a later time, whether the resource locator or information is something available only somewhere out on a distributed network, or perhaps even located on a computing device belonging to the user.

The WWW uses a concept known as hypertext. Hypertext provides the ability to create links within a document to move directly to other information. To activate the link, it is only necessary to click on the hypertext link (e.g., a word or phrase). The hypertext link can be to information stored on a different site than the one that supplied the current information. A URL is associated with the link to identify the location of the additional information. When the link is activated, the client's browser uses the link to access the data at the site specified in the URL. Various implementations of this present disclosure provide a similarly convenient, rapid, and responsive mechanism for getting back to a particular resource found or created, including resources that are stored on distributed databases, web-accessible servers, or even on a particular computing device.

If a client request is for a file or other resource accessible over a distributed network such as shown in FIG. 1, a server locates the file or other resource and sends it to the client. If the client request is for a file or other resource that is stored on a particular computing device, the system can initiate additional security protocols to ensure that a user with proper authentication and authorization is attempting to access the file using the browser on a computing device. An HTTP server also has the ability to delegate work to gateway programs. The Common Gateway Interface (CGI) specification defines a mechanism by which HTTP servers communicate with gateway programs. A gateway program is referenced using a URL. The HTTP server activates the program specified in the URL and uses CGI mechanisms to pass program data sent by the client to the gateway program. Data is passed from the server to the gateway program via command-line arguments, standard input, or environment variables. The gateway program processes the data and returns its response to the server using CGI (via standard input, for example). The server forwards the data to the client using the HTTP.

An application such as a browser displays information to a client/user as pages or documents (referred to as “web pages” or “web sites”). A language is used to define the format for a page to be displayed in the WWW. The language is called Hypertext Markup Language (HTML). A WWW page is transmitted to a client as an HTML document. The browser executing at the client parses the document and displays a page based on the information in the HTML document.

HTML is a structural language that comprises HTML elements that are nested within each other. An HTML document is a text file in which certain strings of characters, called tags, mark regions of the document and assign special meaning to them. These regions are called HTML elements. Each element has a name, or tag. An element can have attributes that specify properties of the element. Blocks or components include unordered list, text boxes, check boxes, and radio buttons, for example. Each block has properties such as name, type, and value.

The following provides an example of the structure of an HTML document:
<HTML> <HEAD> . . . . element(s) valid in the document head </HEAD> <BODY> . . . element(s) valid in the document body </BODY> </HTML>

Each HTML element is delimited by the pair of characters “<” and “>”. The name of the HTML element is contained within the delimiting characters. The combination of the name and delimiting characters is referred to as a marker, or tag. Each element is identified by its marker. In most cases, each element has a start and ending marker. The ending marker is identified by the inclusion of another character, “/” that follows the “<” character.

HTML is a hierarchical language. With the exception of the HTML element, all other elements are contained within another element. The HTML element encompasses the entire document. It identifies the enclosed text as an HTML document. The HEAD element is contained within the HTML element and includes information about the HTML document. The BODY element is contained within the HTML. The BODY element contains all of the text and other information to be displayed.

With reference to the example of FIG. 1, each of computing devices 102 and 103 include a client processor, client device memory 106, a client application 108 and client screen display 110. Each of servers 114-116 include web application server processors 122, server memory 124 and resource matching engine 126.

Client application 108 (e.g., a web browser) on computing device 102-103 receives input from a user in a data entry area of the application rendered on the client display 110. In example aspects, the input entered by the user on a computing device provides a simple, easily remembered, and rapid way for the user to identify and retrieve information, content, resource locators, etc. available over the distributed network or on a particular computing device. The user inputs a short string, or operator that notifies the application (e.g., browser) of the special purpose of the input. In addition to the operator portion of the input, the user inputs a simple, short, and easily remembered “keyword” following the operator. The combination of an operator and the keyword forms a resource designator, which can include short words, strings of textual characters, operators, symbols, punctuation, one or more spaces, or any combination of the preceding that the user enters into the data entry area on the web browser, such as in a standard text search box, tool bar, browser address box, or other user interface element or object displayed on a user interface (UI). The UI is configured to recognize the entered operator, and therefore the entire resource designator, as having a special meaning and as not being a standard query or search instructions.

A UI for an online service in accordance with various implementations of this disclosure includes a back-end storage where the UI can store all of the keywords that have been created by a user to be associated with particular URLs or locations of resources, files, etc. that are accessible over the network or on computing devices. The UI can provide a pop-up box or dialog box as soon as the predetermined operator of a resource designator is entered into a search text box, or other data entry area presented by the client application (e.g., web browser) on a computing device. The pop-up box or dialog box can provide instructions for creating a new resource designator and/or keywords as well as displaying any resource designators and keywords that have already been created. The data entry area of a web browser, such as a text search box, is readily accessible on any browser, browser extension, plug-in, etc., running on any computing device, such as a desktop computer, laptop computer, personal digital assistant, smartphone, tablet computer, etc. The predetermined operator a user enters into the data entry area notifies the browser that what follows is a special shortcut to a resource, and is not a typical search query or URL. This operator can be something as simple and easy to remember as a single space, a short string of characters, punctuation, etc.

Examples of the operator portions of resource designators that could be created to serve as a signal to the UI that the input a user is entering into a text box or other data entry area of a web browser is not a standard search query, could include “me:”, “ww:”, one or more spaces entered into the text box, etc. These types of abbreviated inputs are referred to herein as operators, and upon entry of one of these operators into the data entry area of the web browser, the web browser can be configured to perform one or more of the following functions in different implementations.

When a user enters a resource designator or “web word” in a text search box presented by a web browser connected to an online searching service, the web browser can connect immediately to the desired information, content, or resource locator from whatever computing device is logged into and accessing the online service. The user does not have to remember any particular search terms, URLs, or special sequences of entries that would normally have to be made depending on the service from where a search is initiated. As long as the user is logged into the online service, entry of the web word or resource designator associated with the desired resource in the web browser text box or other data entry area on any client will take the user directly to the desired resource.

In an alternative implementation, the user associates a resource designator, or web word, with an existing or newly created bookmark. An example is described below with reference to FIG. 5. In this implementation, a user need only remember the short resource designator, type or otherwise enter that resource designator into a data entry area of the web browser, and a resource designator matching engine will automatically connect the user to the resource previously associated with the bookmark without the user having to find the bookmark amongst a possibly extensive list of bookmarks.

Another alternative implementation extends the benefits of a localized application launcher that may be available on the operating system of a particular computing device. A UI containing the functionality according to this alternative implementation connects a resource designator entered by a user into a data entry area of the web browser on the computing device through an application programming interface into the operating system of the local computing device. A resource designator matching engine enables the UI to launch an associated application on the computing device. In this implementation, the resource designator matching engine associates the short, and easily remembered resource designator with an object having similar features and functionality on the operating system of a particular computing device to enable rapid launching of an associated application on the computing device.

In additional alternative implementations, the resource designator entered into an application (e.g., a web browser) on a particular computing device can be allowed to open a particular document stored either locally on the computing device, or on another remote computing device that is logged into the same application (e.g., browser). Entry of the resource designator associated with a document, application, or other information that a user wishes to access in this manner could result in the display of a dialog box that warns the user they are about to access a file stored on the memory of a computing device. Additional permissions or access control protocols could be presented to the user in the dialog box to alleviate any security concerns associated with accessing a local file from a web browser application.

In the example of FIG. 1, a web-based environment is illustrated in which various implementations of this disclosure may be practiced. The user of client application 108 running on a client computing device 102, 103 communicates over a network 160 to access information, services, applications, files, data, etc., from servers 114, 116, and 118.

The client application 108 renders a hypertext markup language (HTML) document produced by an application accessed on a web application server. The browser displays the document on a computing device screen display 110 of client computing device 102. The display produced by the browser includes one or more data entry areas such as a text search box. Input of a keyword or phrase by a user into this data entry area on the browser would generally be followed by the user hitting the Enter key, or clicking on a Go icon etc., to cause the application to institute a search for documents, applications, etc. having the keyword. In some instances a user will have to first remember a particular resource locator such as a search web site or online service before even entering the keyword they are looking for. Upon instituting a search, a typical search engine will then return multiple results to the user, many of which may have no relevance, or are not the precise document or application the user was looking for. Users often have certain documents or applications that have so much relevance to what they are doing, they would like a quick and easy way to return to that document or application at a later time, without having to record or remember a complicated URL, and without having to search through numerous previously created bookmarks.

Each of computing devices 102-103 can represent various forms of processing devices. Example processing devices include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. Computing devices 102-103 and servers 114-118 may be provided access to or receive application software executed or stored on any of the other computing devices 102-103 and servers 114-118.

Servers 114-118 may be any system or device having a processor (e.g., 122), a memory (e.g., 124), and communications capability for providing content to the electronic devices. In some example aspects, servers 114-118 can be a single computing device, for example, a computer server. In other embodiments, servers 114-118 can represent more than one computing device working together to perform the actions of a server computer (e.g., cloud computing). Further, servers 114-118 can represent various forms of servers including, but not limited to a web server, an application server, a proxy server, a network server, or a server farm.

In some aspects, computing devices 102-103 and servers 114-118 may communicate wirelessly through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, WiFi, or other such transceiver.

In some aspects, network environment 100 can be a distributed client/server system that spans one or more networks, for example, network 160. Network 160 can be a large computer network, for example, a local area network (LAN), wide area network (WAN), the Internet, a cellular network, or a combination thereof connecting any number of mobile clients, fixed clients, and servers. Further, network 160 can include, but is not limited to, any one or more of the following network topologies, including a bus network, a star network, a ring network, a mesh network, a star-bus network, tree or hierarchical network, and the like. In some aspects, communication between each client (e.g., computing devices 102-103) and server (e.g., servers 114-118) can occur via a virtual private network (VPN), Secure Shell (SSH) tunnel, or other secure network connection. In some aspects, network 160 may further include a corporate network (e.g., intranet) and one or more wireless access points.

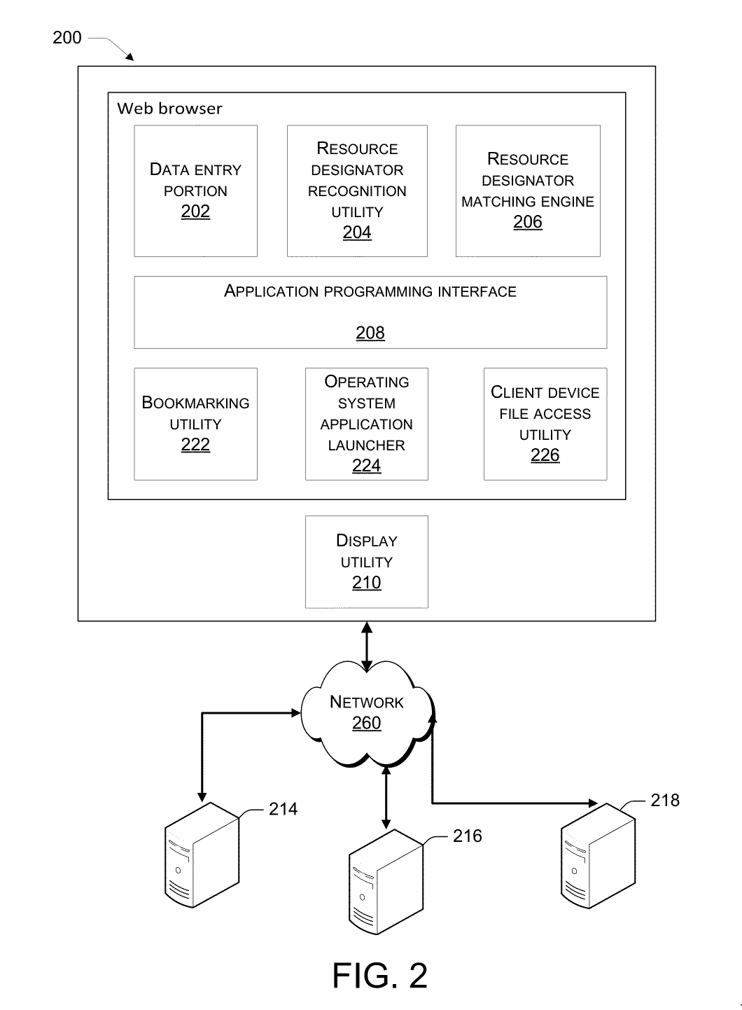

FIG. 2 is a block diagram illustrating example components of a system for providing access to a resource for an application running on a computing device. As shown in FIG. 2, a client computing device 200 is connected over a network 260, such as the Internet, to web application host servers 214, 216, and 218. The client computing device 200 includes an application, which is a web browser in the example of FIG. 2. The web browser application includes a data entry portion 202, a resource designator recognition utility 204, a resource designator matching engine 206, application programming interface 208, and a display utility 210. Various implementations can also comprise additional modules that may include a bookmarking utility 222, operating system application launcher 224, and computing device file access utility 226. Although FIG. 2 illustrates these various components as part of the web browser on a client computing device, at least a portion of these components could be contained on one or more servers communicatively coupled to the computing device, or in some instances at least a portion of these components may be contained on one or more computing devices that could be communicatively coupled in a peer-to-peer (P2P) configuration. For example, resource matching engine 126 can be used in conjunction with the web browser application of FIG. 2.

When a user attempts to access one or more web-based applications located on host servers 214, 216, and/or 218, the user may have to enter various credentials to gain access to each application. The credentials may include authentication parameters such as username and password to verify that the user is who they say they are, and/or authentication parameters that specify the extent of authorization that particular user has when operating the application.

In accordance with various implementations of this disclosure, a user has decided they want a quick and easy way to get back to information, such as a document, application, content, or resource locator they have discovered somewhere on a distributed network, or possibly have downloaded and stored in the memory of one or more computing devices. A UI on a computing device has designated a predetermined short string of characters, punctuation, spaces, etc., as an operator that, when entered by a user into the data entry portion 202 of the web browser, will result in the functionality described herein. The user enters such a predetermined operator into the data entry portion 202, and follows the operator with a keyword or phrase that the user will easily remember to get back to the information or resource locator. The combination of the operator and keyword is referred to as a resource designator or web word. As soon as the user has entered the short operator into the data entry area, a dialog box pops up and provides the user with instructions for creating a new resource designator, and may also display previously created web words if desired.

The resource designator recognition utility 204 provides the functionality that allows the UI to immediately recognize entry of the operator portion of a resource designator into a data entry area of the browser. The UI then enters a mode where resource designator matching engine 206 of the browser is prepared to either assign a new resource designator to a resource, or retrieve a resource previously assigned and matched with the keyword entered by the user as part of the resource designator. Entry of the operator portion of the resource designator notifies the UI to not perform a typical search based on the information being entered, but instead to go directly to the resource matched with the resource designator.

In various implementations of this disclosure the UI matches the resource designator through application programming interface 208 to bookmarking utility 222 to allow association of the resource designator with a URL that a user has previously bookmarked.

The UI can also associate the resource designator or web word through the application programming interface 208 to other possible locations of resources, such as the memory on a particular computing device. The operating system application launcher 224 extends the feature sometimes found on the operating systems of individual computing devices allowing for rapid launching of an application resident in the memory of the device. A web word created by a user to provide quick access to a resource somewhere on a distributed network can also link the user directly through application programming interface 208 to the application launching functionality on an individual computing device.

Various implementations can also include a computing device file access utility 226 that enables a user to connect using the browser on a computing device directly to a file or application stored in memory on that device, or other devices logged into the same browser and connected to the computing device with remote access software. The browser, or a special browser extension with the computing device file access utility can provide additional security protocols before allowing the web browser to access the files stored on a computing device. The security protocols could include a pop-up notification that the browser is attempting to access files on the computing device, and requiring additional user authentication and authorization.

Any resource retrieved by user input of a matched resource designator into the data entry area of the browser can then be displayed to the user on whatever computing device they are working from using the display utility 210.

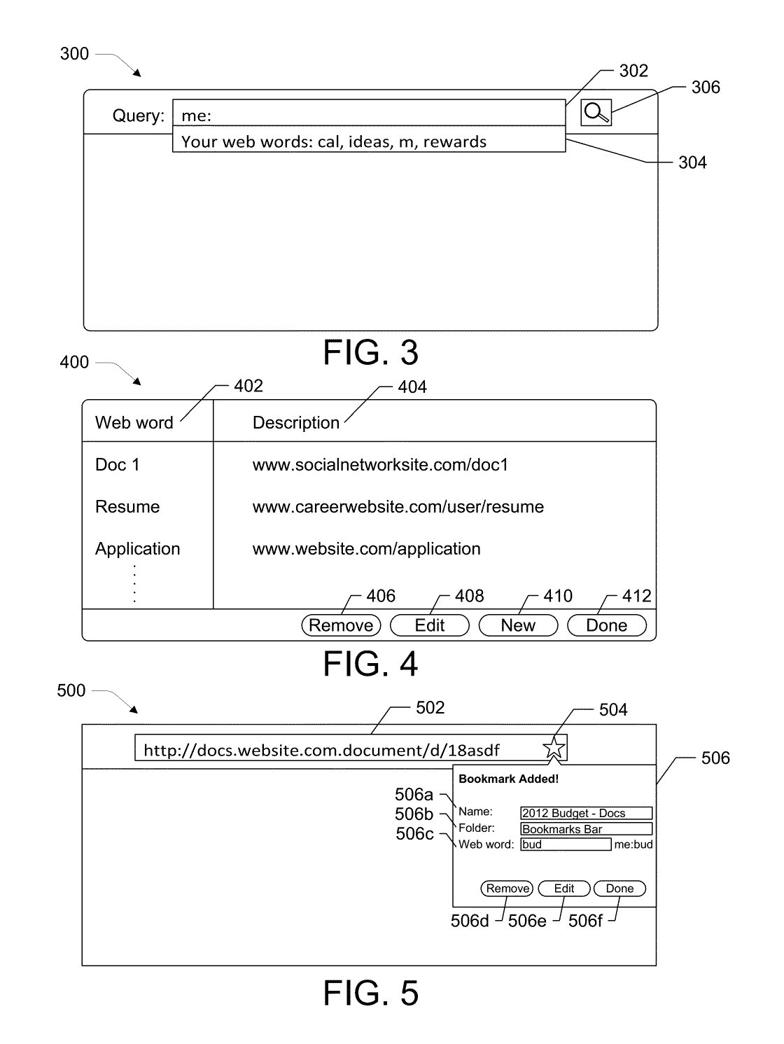

FIG. 3 illustrates an example of a graphical interface which provides access to a resource for an application running on a computing device. In the example of FIG. 3, an application 300 includes a data entry area 302 for entering a query, a search button 306 for initiating a search based on the entered query, and a list of web words 304 for listing out the keywords which a user of application has previously stored or created.

Application 300 can be, but is not limited to, a web browser. Data entry area 302 can be a text search box, tool bar, task bar, address box, etc. on a web browser, browser extension, browser plug-in, applet, servlet, or other application or programming script enabled to receive input from a user. In example aspects, data entry area 302 can include separate input boxes (e.g., a text search box and a separate address bar).

A user of application 300 may wish to access a resource on the Internet, on the local device running application 300, or on a remote device. Thus, the user can enter an operator within data entry area 302. In the example of FIG. 3, the operator is entered as “me:”. As noted above, other operators can be used (e.g., one or more spaces, or other predefined strings of characters).

Application 300 can recognize the entry of the operator within data entry area 302, and in response, can display list of web words 304. List of web words 304 includes all of the web words predefined by the user. In this regard, the predefined web words can be stored locally (e.g., on the device running application 300) or on a server associated with application 300. The web words can be stored in association with a user profile, which can reside either locally or on a server. In example aspects, user authentication is required for enabling web words associated with a particular user profile.

A user can select (e.g., via mouseclick, touch input) one of the web words displayed in list of web words 304, or can manually enter the web word using the list of web words 304 as a reference. In addition, application 300 can provide for predictive text for web words, such that as the user enters additional letters following the operator, list of web words 304 is updated to list only those web words which include, or start with, the additional letters.

FIG. 4 illustrates an example of a graphical interface for creating or editing keywords associated with respective resources. FIG. 4 illustrates an interface 400, which can be invoked, for example, by a button or menu option (not shown) within application 300.

Interface 400 provides a list of all web words stored for a user (e.g., based on a user profile stored locally or on a server associated with application 300). The web words are provided in column 402, and corresponding descriptions of the web words are provided in column 404. In the example of FIG. 4, the description includes a URL of the resource identified by the web word. However, other descriptions (e.g., text descriptions) can be provided in the alternative or in addition.

Interface 400 further includes button 406 to remove web words, and button 408 to edit existing web words. In addition, interface 400 includes button 410 to create a new web word and button 412 to exit interface 400 and return to application 300.

FIG. 5 illustrates an example of a graphical interface for creating a new keyword from a bookmark interface in a web browser. In the example of FIG. 5, web browser 500 includes an address bar 502 and a bookmark button 504 for adding the current URL in address bar 502 as a bookmark for a user (e.g., in association with a user profile).

Upon clicking on bookmark button 504, web browser 500 displays a bookmark interface 506. Bookmark interface 506 includes fields 506a and 506b, which respectively display the name and folder associated with the bookmark. Bookmark interface 506 also includes buttons 506d, 506e and 506f, for removing, editing and completing operations associated with the current bookmark.

In addition, bookmark interface 506 includes field 506c for user entry of a web word. In the example of FIG. 5, the user enters “bud” in association with the “me:” operator. This can create the keyword “bud” to be associated with the current bookmarked.

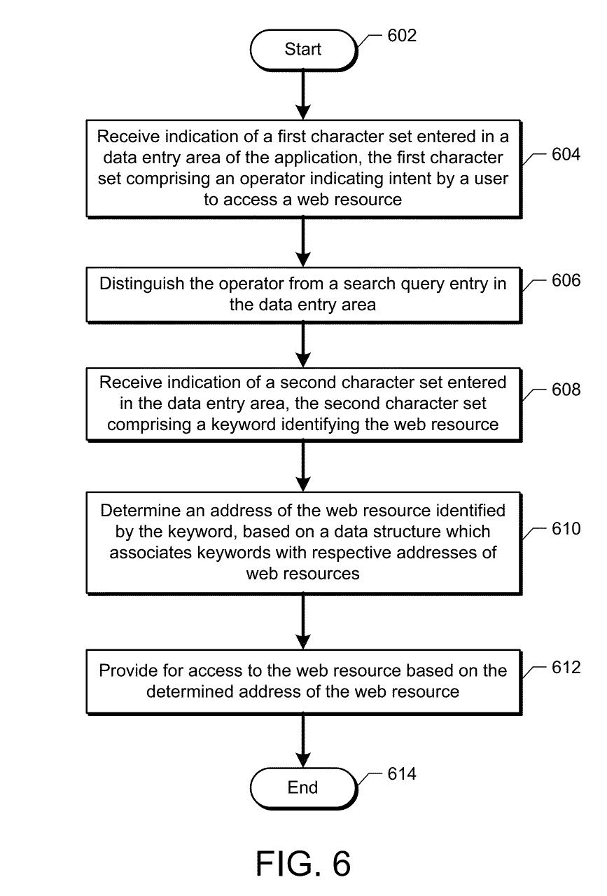

FIG. 6 illustrates an example process by which access to a resource for an application running on a computing device is provided. Following start block 602, indication of a first character set entered in a data entry area of the application (e.g., a web browser) is received at step 604. The first character set includes an operator indicating intent by a user to access a resource. The data entry area can be a text search box. The operator can include a series of predefined characters. For example, the operator can be one or more spaces.

At step 606, the operator is distinguished from a query entry (e.g., a search query, entry of a URL) in the data entry area. At step 608, indication of a second character set entered in the data entry area is received. The second character set includes a keyword identifying the resource. Receiving the indication of the second character set can include receiving text entered by the user, the text comprising the keyword.

A list of the keywords in the data structure can be provided for display in response to distinguishing the operator. The list of keywords can be displayed in association with the data entry area, and receiving indication of the second character set can include receiving a selection by the user of the keyword from the displayed list of keywords. The list of keywords can correspond to predictive text which is updated as characters from the second character set are entered.

At step 610, an address of the resource identified by the keyword is determined, based on a data structure which associates keywords with respective addresses of resources. The data structure can be stored locally on the computing device or may be stored on a server associated with the application. The data structure may correspond to a user profile of the user.

The address can provide the location of the resource in several different manners. For example, the address can be a uniform resource locator (URL). The address can also be a specific machine identifier and file path for a location on another computing device communicatively coupled to the computing device. In another example, the address can be for a bookmark of the application. The address can also be for a bookmark on a web server communicatively coupled to the computing device. In another example, the address can be for an operating system application launcher on one of the computing device or another computing device communicatively coupled to the computing device. The address can also be for a file stored on the computing device. In another example, the address can be for a file stored on a remote computing device communicatively coupled to the computing device through remote access software.

At step 612, access to the resource is provided based on the determined address of the resource. Receiving indication of the first character set, distinguishing the operator, receiving indication of the second character set, determining the address and providing for access can be performed by the computing device. Alternatively, or in addition, the application can be associated with a server, and receiving indication of the first character set, distinguishing the operator, receiving indication of the second character set, determining the address and providing for access can be performed by the server. Alternatively, or in addition, steps 604-612 can be performed using a combination of the computing device and the server associated with the application. The process then ends at end block 614.

Thus, the subject technology can enable a user to quickly and easily retrieve desired information from an online service or other source over a distributed network such as the Internet, or even from one or more of the user's own computing device(s). A UI rendered on a computing device displays an object such as a text search box, tool bar, task bar, address box, or other data entry area, on an application, such as a web browser, browser extension, browser plug-in, applet, servlet, or other application or programming script enabled to receive input from a user. The user can provide input to the application (e.g., web browser) using any number of input mechanisms, including a keyboard, voice recognition, touch screen, mouse, etc., with the input comprising a predetermined string of characters, operators, or other select designators, and a meaningful keyword or other shortcut reference. Upon receiving the predetermined string of characters or operators entered into the text search box or other data entry area of the web browser interface by a user, the UI recognizes the input as having a special purpose and distinguishes the input from a standard search request. A user also provides additional input following the predetermined operators in the form of a keyword (or key phrase). The user creates the customizable keyword to be a short and easily remembered reference to a resource locator or other information (hereinafter simply referred to as resources) that the user might like to access at a later time. The combination of a predetermined operator and keyword is referred to herein as a resource designator or “web word,” a reference to their functionality of providing quick access to resources over the web or other networks. The UI can parse the input and associate the resource designator with a Uniform Resource Identifier (URI), or in particular, a Uniform Resource Locator (URL). The associated URL links directly to desired information or content on any server or computing device communicatively coupled to the device on which a user entered the resource designator.

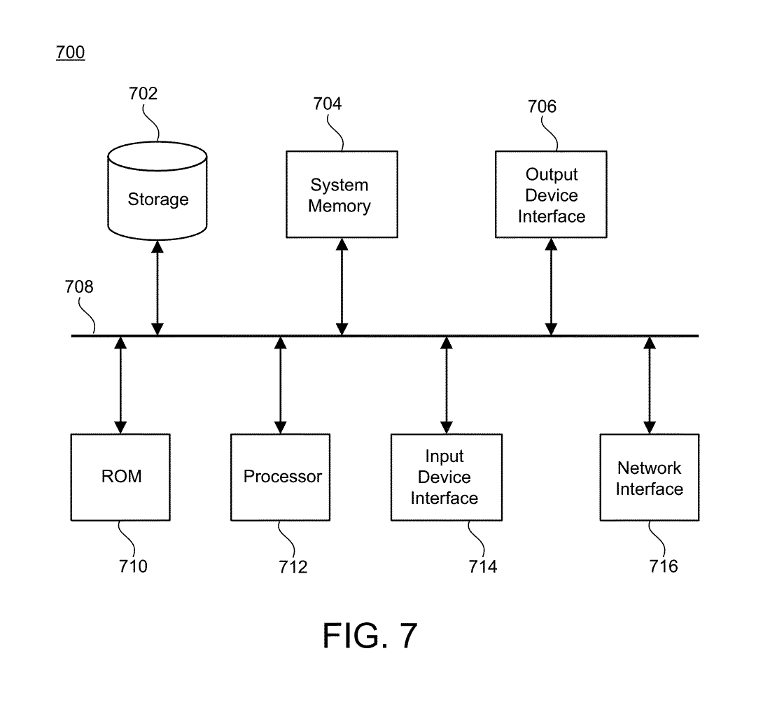

FIG. 7 conceptually illustrates an example electronic system with which some implementations of the subject technology can be implemented. Electronic system 700 can be a computer, phone, PDA, or any other sort of electronic device. Such an electronic system includes various types of computer readable media and interfaces for various other types of computer readable media. Electronic system 700 includes a bus 708, processing unit(s) 712, a system memory 704, a read-only memory (ROM) 710, a permanent storage device 702, an input device interface 714, an output device interface 706, and a network interface 716.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (for example, a magnetic or optical disk and its corresponding disk drive) as permanent storage device 702.

Other implementations use a removable storage device (for example, a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, or ROM 710. For example, the various memory units include instructions for providing access to a resource in accordance with some implementations. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, for example, alphanumeric keyboards and pointing devices (also called “cursor control devices”). Output device interfaces 706 enables, for example, the display of images generated by the electronic system 700. Output devices used with output device interface 706 include, for example, printers and display devices, for example, cathode ray tubes (CRT) or liquid crystal displays (LCD). Some implementations include devices, for example, a touchscreen that functions as both input and output devices.

Finally, as shown in FIG. 7, bus 708 also couples electronic system 700 to a network (not shown) through a network interface 716. In this manner, the computer can be a part of a network of computers (for example, a local area network (“LAN”), a wide area network (“WAN”), or an Intranet, or a network of networks, for example, the Internet. Any or all components of electronic system 700 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification and any claims of this application, the terms “computer,” “server,” “processor,” and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's computing device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a computing device (e.g., for purposes of displaying data to and receiving user input from a user interacting with the computing device). Data generated at the computing device (e.g., a result of the user interaction) can be received from the computing device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

1. A method of providing access to a resource for an application running on a computing device, the method comprising:
receiving indication of a first character set entered by a user in a data entry area of the application, the first character set comprising a text string, and the data entry area corresponding to a text input box;
determining that the text string matches an operator, wherein the operator is a predefined text string and indicates intent by the user to access a resource;
receiving indication of a second character set entered in the data entry area, the second character set comprising a keyword identifying the resource;
determining, in response to determining that the text string matches the operator, an address of the resource identified by the keyword, based on a data structure which associates keywords with respective addresses of resources; and
providing for access to the resource based on the determined address of the resource.

2. The method of claim 1, wherein receiving the indication of the second character set comprises receiving text entered by the user, the text comprising the keyword.

3. The method of claim 1, further comprising:
providing, in response to determining that the text string matches the operator, a list of the keywords in the data structure for display,
wherein the list of keywords is displayed in association with the data entry area, and
wherein receiving indication of the second character set comprises receiving a selection by the user of the keyword from the displayed list of keywords.

4. The method of claim 3, wherein the list of keywords corresponds to predictive text which is updated as characters from the second character set are entered.

5. The method of claim 1, wherein the data entry area is a text search box.

6. The method of claim 1, wherein the application is a web browser.

7. The method of claim 1, wherein the address is a uniform resource locator (URL).

8. The method of claim 1, wherein the address is a specific machine identifier and file path for a location on another computing device communicatively coupled to the computing device.

9. The method of claim 1, wherein the address is for a bookmark of the application.

10. The method of claim 1, wherein the address is for a bookmark on a web server communicatively coupled to the computing device.

11. The method of claim 1, wherein the address is for an operating system application launcher on one of the computing device or another computing device communicatively coupled to the computing device.

12. The method of claim 1, wherein the address is for a file stored on the computing device.

13. The method of claim 1, wherein the address is for a file stored on a remote computing device communicatively coupled to the computing device through remote access software.

14. The method of claim 1, wherein the operator comprises one or more spaces.

15. (canceled)

16. The method of claim 1, wherein receiving indication of the first character set, determining that the text string matches the operator, receiving indication of the second character set, determining the address and providing for access are performed by the computing device.

17. The method of claim 1, wherein the application is associated with a server, and wherein receiving indication of the first character set, determining that the text string matches the operator, receiving indication of the second character set, determining the address and providing for access are performed by the server.

18. A system for providing access to a resource for an application running on a computing device, the system comprising:
one or more processors; and
a machine-readable medium comprising instructions stored therein, which when executed by the processors, cause the processors to perform operations comprising:
receiving indication of a first character set entered by a user in a text search box of the application, the first character set comprising a text string;
determining that the text string matches an operator, wherein the operator is a predefined text string and indicates intent by the user to access a resource;
receiving indication of a second character set entered in the text search box, the second character set comprising a keyword identifying the resource;
determining, in response to determining that the text string matches the operator, an address of the resource identified by the keyword, based on a data structure which associates keywords with respective addresses of resources; and
providing for access to the resource based on the determined address of the resource.

19. The system of claim 18, wherein the application is a web browser.

20. A non-transitory machine-readable medium comprising instructions stored therein, which when executed by a system, cause the system to perform operations comprising:
receiving indication of a first character set entered by a user in a data entry area of an application running on a computing device, the first character set comprising a text string, and the data entry area corresponding to a text input box;
determining that the text string matches an operator, wherein the operator is a predefined text string and indicates intent by the user to access a resource;
receiving indication of a second character set entered in the data entry area, the second character set comprising a keyword identifying the resource;
determining, in response to determining that the text string matches the operator, an address of the resource identified by the keyword, based on a data structure which associates keywords with respective addresses of resources; and
providing for access to the resource based on the determined address of the resource.
